(19) United States
(12) Patent Application Publication
(10) Pub. No.: US 2010/0020983 A1
(43) Pub. Date: Jan. 28, 2010

(54) Wireless speaker dongle with auxiliary audio output

(76) Inventor: Nigel Waites, Lakeville, MN (US)

Correspondence Address: BECK AND TYSVER P.L.L.C., 2900 THOMAS AVENUE SOUTH, SUITE 100, MINNEAPOLIS, MN, 55416, US

(21) Appl. No.: 12/460,043

(22) Filed: Jul. 13, 2009

Related U.S. Application Data
(60) Provisional application No. 61/134,628, filed on Jul. 11, 2008.

(51) Int. Cl. H04B 5/00

(52) U.S. Cl. 381/79

(57) ABSTRACT

A wireless audio signal transmitter is presented that routes audio signals to either a wired or a wireless sound output device. The transmitter selects whether the audio signal is transmitted over a wireless antenna to a wireless device, or is transmitted to a physically attached device. The transmitter may take the form of a USB dongle or a wireless device charging station. The transmitter detects whether the wireless audio output device is powered on and in communication with the transmitter to determine how to route the audio signal received from the computer. If the wireless audio output device is connected to the transmitter, the audio signal is routed to the wireless audio output device. If there is no connection, then the audio signal is routed to the wired audio output device.

### CROSS REFERENCE TO RELATED APPLICATION

The present invention claims the benefit of U.S. Provisional Application No. 61/134,628, filed Jul. 11, 2008.

### FIELD OF THE INVENTION

The present invention relates to the field of wireless headset and speaker systems. More particularly, embodiments are presented that relate to a dongle or other wireless transmitter usable in a computer system to provide access to both a wireless audio output device and a wired audio output device.

### BACKGROUND

As shown in FIG. 1, the use of wired and wireless speaker systems in a computer environment is well known. A computer 100 is shown in that figure which uses a wired connection 110 to communicate with a wired speaker system 200. The speaker system 200 could be a standard stereo system or a 5.1 or 7.1 multi-channel home theater speaker system. In this example, the wired connection 110 is an analog connection in the form of a common headphone jack, otherwise known as a 3.5 mm “mini” stereo connector. Other analog or digital connectors to the wired speaker system 200 are well known. For example, another common connector for computer speaker systems is a USB digital connection. USB connections send digital data containing an audio signal to the speaker systems, which then convert the digital signal to an analog audio output.

The computer 100 is also connected to a wireless headset 300 via a USB wireless dongle 310. The dongle 310 is connected to the computer 100 through a USB digital connection 120. The wireless dongle 310 communicates with the wireless headset 300 via wireless signals 312 transmitted via antenna 314. The wireless signals 312 may conform to a well-known wireless transmission protocol, such as the Bluetooth protocol. Alternatively, the wireless signals 312 may be formatted and transmitted by a proprietary protocol that is shared between the wireless dongle 310 and headset 300. The Computer 100 may play a variety of audio sources 130, include optical disks (such as CDs or DVDs), media files stored elsewhere on the computer 100 (such as MP3 audio or AVI multimedia files), streamed sources received over a network such as the Internet, or even external sources received via a wireless or wired connection by the Computer 100. Alternatively, the computer may play audio signals that originate from another computer program, such as a word processor, web browser, or computer game application.

Most modern computers, such as those running the Windows or Mac OS X operating systems, are capable of playing audio sources over a variety of output options. In the computer 100 shown in FIG. 1, audio sources 130 may be played over either the wired speaker system 200 or the wireless headset 300. In order to allow a user to select the appropriate output device, computers generally allows the users to select the output device through an audio preferences dialog. In the Windows XP operating system, this is available in the Sounds and Audio Devices control panel. In the Mac OS X 10.5 operating system, the selection is made through the Sound system preference. The ability to select an output device is represented by audio preferences box 140 in FIG. 1. The selection made in the audio preferences 140 by the user determines whether (and which) the audio sources 130 are played through the wired speaker system 200 or the wireless headset 300. In FIG. 1, the solid line to the headphone jack 110 and the dashed line to the USB port 120 indicates that the audio preferences 150 are set to play the audio source through the wired speaker system 200 and not the wireless headset 300.

Operating systems are commonly designed to update the audio preferences 150 when there is a change in the environment of the computer. For example, when the wireless dongle 310 is connected to the computer 100, the operating system will detect the dongle 310 and realize an audio output device has been attached. The operating system will then update the audio preferences 150 to indicate that future playing of audio sources 130 will occur through the wireless headset. If the user wishes to play audio sources 130 through the wired speaker system 200 after attaching the wireless dongle 310, the user may manually change the audio preferences 140.

### SUMMARY

One embodiment of the present invention provides a wireless audio output transmitter (such as a dongle device or charging base station) that routes audio signals to either a wired or a wireless sound output device. The dongle may be a USB device that receives audio signals from an attached computer system. The dongle internally selects whether the audio signal is transmitted over a wireless antenna to a wireless device, or is transmitted to a physically attached device.

The wired audio output device may attach to the dongle via an analog port such as a standard 3.5 mm headphone jack. In that case, the dongle contains a digital to analog converter to convert the digital signal received over the USB port to an analog signal that can be used by the wired audio output device. Alternatively, the wired audio output device may connect to the dongle through a second USB connector.

The wireless dongle detects whether the wireless output device is powered on and in communication with the dongle. In one embodiment, the wireless dongle uses this connection status to determine how to route the audio signal received from the computer. If the wireless output device is communicating with the dongle, the audio signal is routed to the wireless output device. If there is no connection, then the audio signal is routed to the wired speaker system.

In another embodiment, the computer system can be a dedicated gaming console. In this embodiment, it can be useful for the wireless output device to also provide input back to the game console. For example, the wireless output device may accept game controller inputs that can be transmitted back to the wireless dongle and the game console.

### BRIEF DESCRIPTION OF THE DRAWINGS

FIG. 1 is a schematic diagram showing a prior art computer system communicating with a wired and a wireless audio output device.

FIG. 2 is a schematic diagram showing a computer system using the wireless dongle of the present invention to communicate with a wired and a wireless audio output device.

FIG. 3 is a schematic diagram of a second embodiment of the present invention wireless dongle using a USB connection to connect to a wired audio output device.

FIG. 4 is a schematic diagram of a third embodiment of the present invention in the form of a wireless audio output device transmitter that also functions as a charging stand for the wireless audio output device.

FIG. 5 is a schematic diagram of a fourth embodiment wherein the computer system is a dedicated game console, and the wireless input device allows the user to provide input back to the game console.

### DETAILED DESCRIPTION OF THE INVENTION

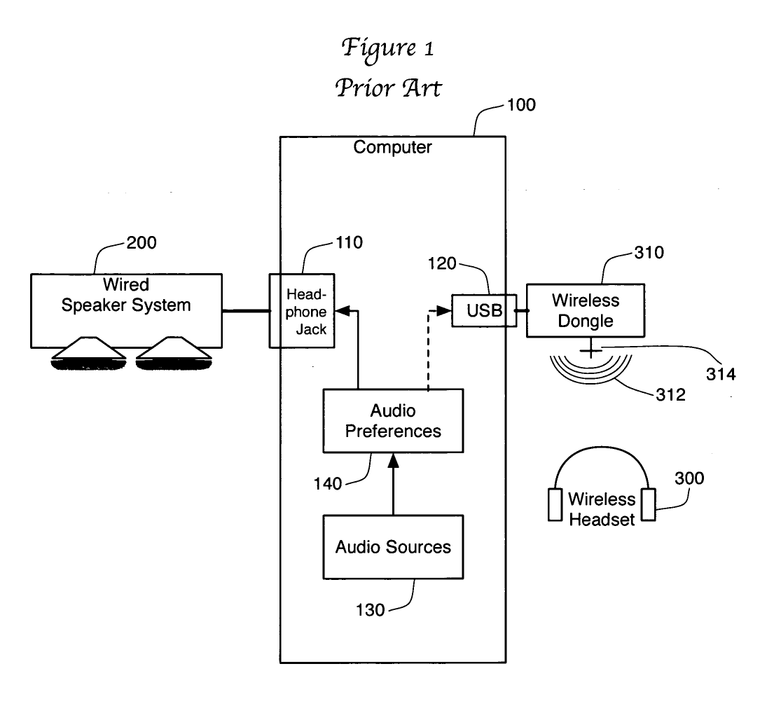

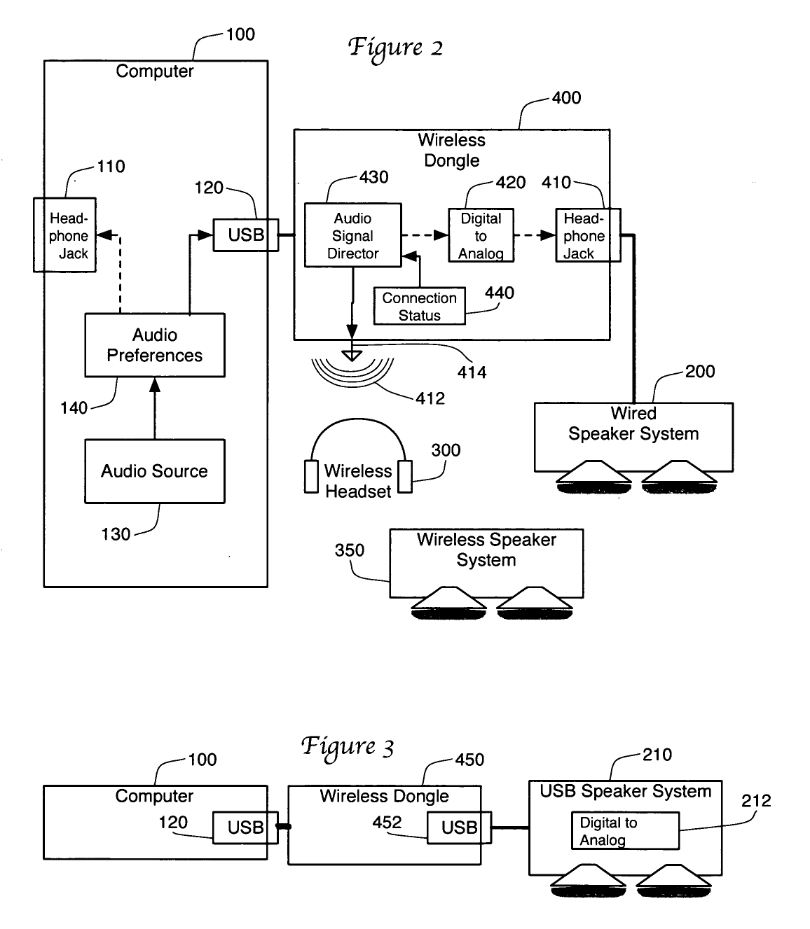

FIG. 2 shows a present invention wireless dongle 400 in use with the same prior art computer 100, wired speaker system 200, and wireless headset 300 shown in FIG. 1. The wireless dongle 400 connects to the USB port 120 of the computer 100, and further transmits a wireless signal 412 via an antenna 414 to the wireless headset 300. In this way, the wireless dongle 400 of the present invention behaves similarly to the prior art dongle 310 shown in FIG. 1. In addition to the wireless headset 300, the wireless dongle 400 could function equally well with other wireless audio output devices, such as a wireless speaker system 350.

The improvement in the wireless dongle 400 is in its ability to direct the audio signal received via USB port 120 to more than one audio output device. This is made possible by incorporating into the dongle 400 a wired connection port such as a headphone jack (i.e., a 3.5 mm “mini” plug) 410. This headphone jack 410 can be used by wired audio output devices such as the wired speaker system 200 or a wired headphone system (not shown in FIG. 2). To transmit the audio signal received via USB port 120 over the analog headphone jack 410, it is necessary to incorporate a digital-to-analog converter 420 within the dongle 400 as well as other related circuitry such as an audio amplifier (not shown).

One of the primary benefits of the wireless dongle 400 is its ability to automatically route the audio signal between the wired audio output device 200 and the wireless audio output device 300 without any user interaction with the computer 100 or the audio preferences 140. This is accomplished by using audio signal director logic 430 onboard the dongle 400. This logic directs the audio signal either to the wired connector (such as jack 410) or to the wireless antenna 414 and its associated transmission circuitry (not shown).

In the preferred embodiment, the audio signal director logic 430 basis its routing decision on whether or not the wireless output device (such as headset 300 or wireless speaker 350) is currently connected to the dongle 400. This connection status 440 is set to indicate a connection, which should occur whenever the wireless output device 300, 350 is powered on and within the communication range of the dongle 400. When this status 440 indicates a connection, the audio signal director logic 430 routes the signal to the wireless output device 300, 350. If the wireless device 300, 350 is outside of range or unpowered, the connection status 440 would indicate that there is no current connection. In this case, the audio signal director would route the signal to the wired audio output device 200 via the digital to analog converter, the headphone jack, and their associated circuitry.

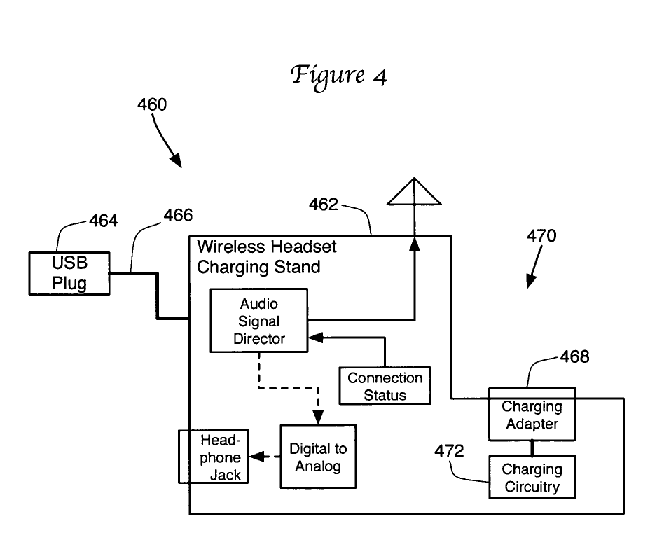

FIG. 3 shows a second embodiment of the present invention wireless dongle 450 where the headphone jack 410 is replaced with a USB port 452. In this embodiment, the wireless dongle 450 communicates with a USB-based wired speaker system 210 through the USB port 452. Because the USB port 452 uses a digital connection, the USB speaker system 210 must contain its own digital to analog converter 212. This would allow the removal of the digital-to-analog circuitry 420 from this embodiment of the wireless dongle 450. The other components 414, 430, 440 from the first embodiment of the wireless dongle 400 would remain in this second embodiment 450 and would function similarly, even though they are not shown in FIG. 3. Of course, it would be possible and within the scope of the present invention to combine embodiments 400, 450 so that the wireless dongle 450 was able to connect to a wired speakers system 200, 210 through both a headphone jack 410 and a USB port 452. In fact, known systems that detect the presence of a connection on the headphone jack 410 and USB port 452 could be added to allow the audio signal director 430 to automatically select the connected interface 410, 452 whenever there is no connection to the wireless output device 300, 350.

FIG. 4 shows a third embodiment 460 of the present invention, where the headphone jack embodiment 400 of FIG. 2 has been implemented in the context of a wireless headset charging stand 462 which connects to the computer 100 via a USB plug 464 and cable 466. This embodiment includes a charging adapter 468 that is configured to connect to the wireless headset 300. For example, the charging stand 462 could have a cradle portion 470 designed to receive the headset 300 for recharging. The headset 300 would fit in the cradle 470, and charging connectors on the headset 300 (not should) would interface with and form an electrical connection with the charging adapter 468. Charging circuitry 472 within the charging stand 462 would then provide the power necessary to charge a battery (not shown) within the headset 300. This configuration would allow the wired audio output device 200 to connect at the charging stand 462 rather than a dongle 400 that is directly connected to the USB port 120 of the computer 100. In many usage settings, the configuration of this embodiment 460 would be preferred.

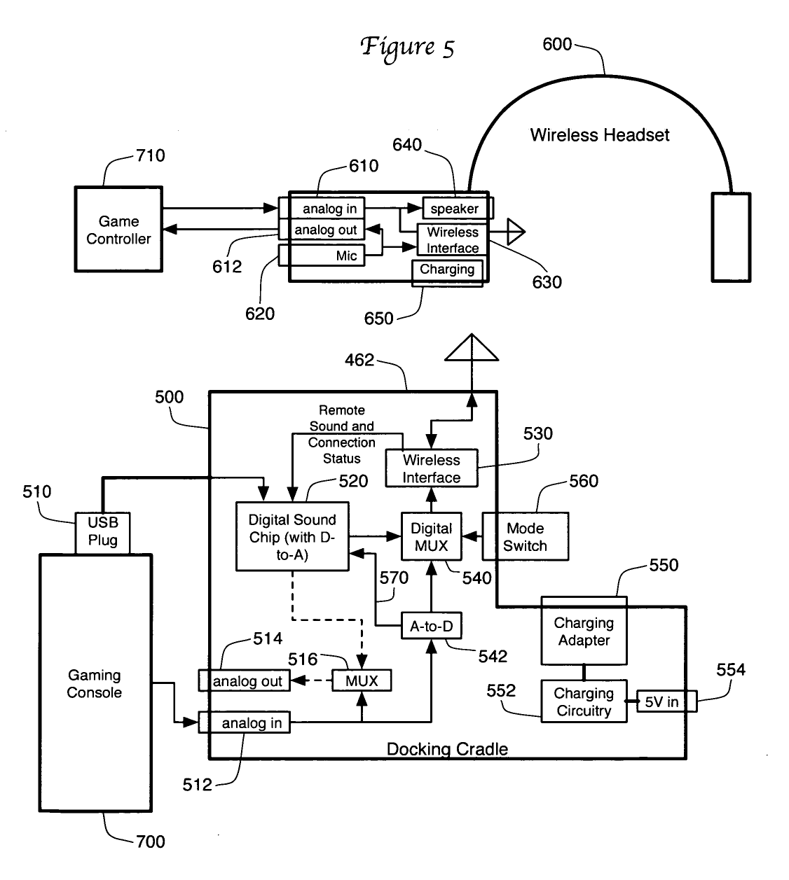

FIG. 5 shows a fourth embodiment of the present invention including a docking cradle 500 and a wireless headset 600. This embodiment is designed to function in a variety of environments ranging from gaming consoles to personal computer environments.

FIG. 5 shows the docking cradle attached to a gaming console 700. This gaming console 700 uses one or more game controllers 710 that interact with the games running on the console 700. The controllers 710 may be connected to the console 700 through a wired or wireless connection. With some gaming consoles, game sound is provided through analog outputs found on the console 700. These consoles may also have a USB port, but this port is typically used for purposes other than sound output, such as for microphone input. In FIG. 5, the docking cradle 500 is shown attached to a gaming console 700 through a USB plug 510 and an analog input 512. This use implies that the docking cradle receives analog sound input through plug 512, while also providing a microphone output to the console 700 through the USB plug 510. In normal use, the analog output 514 of the docking cradle 500 would be attached to a wired speaker system such as a standard stereo or home theater audio system as described above.

Some game system controllers 710, such as the standard Xbox 360 controller, have analog audio inputs and outputs in the controller 710 itself. The input and output may be placed on the same physical jack. In the Xbox 360, the controller 710 input is used for a microphone input in multiplayer games, while the controller 710 output is used for multiplayer chat sound output. The headset 600 of FIG. 6 is capable of integrating with this type of game controller 710 by providing an analog input 610 and output 612 at the headset 600 that plug directly into the controller 710.

To provide the microphone capabilities, the headset 600 includes a microphone 620 integrated into the headset. This microphone 620 can utilize an arm to place the microphone closer to the user's mouth, but in preferred embodiment the microphone is integrated into the ear cup of the headset 600. In some embodiments, the microphone 620 will utilize known echo-cancelling technology to improve sound quality. As shown in FIG. 5, the signal from the microphone 620 can be fed both to-the analog output 612 for receipt by the game controller 710, and also to the headset wireless interface 630. The wireless interface 630 of the headset communicates with the wireless interface 530 of the docking cradle to allow two-way communications between the headset 600 and the cradle 500. In this way, sound originating at the cradle 500 can be played through the headset 600, while microphone input originating at the headset 600 can be received by the cradle 500.

The sound is provided to the user of the headset 600 through a speaker 640 in each ear cup. The speaker 640 may receive sound from the docking cradle 500 through the wireless interface 530, 630, or can receive sound locally through the analog input 610 on the headset 600. In a simplified environment, these two sources are combined together, such that both sources will be heard simultaneously. Alternatively, a switch can be provided to select between these sources.

The headset 600 is powered by rechargeable batteries (not shown) that are charged by the charging circuit 650. The charging circuit 650 is designed to cooperate with a charging adapter 550 found on the docking cradle 500. The charging adapter 550 is powered by charging circuitry 552 in the cradle, which obtains its power from a 5 volt input plug 554. The cradle is designed such that all internal circuitry other than the charging circuitry 552 can operate through power obtained from the USB plug 510. Alternatively, the cradle 500 can use the power from the 5 volt input plug 554 to power the entire cradle 500, thereby eliminating the need to use the USB plug 510 for power.

The cradle 500 generally integrates with the gaming console 700 through USB plug 510 and analog input 512, and integrates with the wireless headset 600 through the wireless interface 530. The analog input 512 can be provided directly to the analog output 514 via a MUX circuit 516 that also integrates an analog output signal from a digital sound chip 520. The sound chip 520 receives digital sound input from the USB plug 510 and from the wireless interface 530. The chip 520 outputs analog output (using an integrated digital to analog converter) to the analog output 514 via MUX 516, and outputs digital sound to the wireless interface 530 via a digital MUX 540. The digital MUX 540 also receives a signal from the analog input 512 after that signal passes through analog-to-digital converter 542. This MUX 540 can merge or select between the two sound inputs that it receives. In one embodiment, the selection of sources is made via a physical mode switch 560 found on the docking cradle 500.

The cradle 500 and headset 600 shown in FIG. 5 has the advantage of being able to operate in multiple environments. For instance, some Microsoft Xbox games (such a karaoke games) allow the use of a USB microphone. With these games, output from the analog outputs of the Xbox console 700 are received by the cradle 500 at input 512, converted to a digital signal, and sent to the wireless headset 600. Voice is received by the microphone 620, converted to digital signal and sent to the cradle 500, which then provides the input back to the gaming console 700 through USB plug 510.

Other Xbox games provide multi-player sound through the game controller 710. In these games, general game sound is still provided to the analog input of the cradle 500 and can be transmitted to the headset 600 as described above. Multiplayer sound, however, is sent to the game controller and output to the analog input 610 of the headset 600 (where it can be provided to the speakers 640 along with the general game sound received from the cradle 500). In these games, the input to the microphone 620 of the headset 600 is provided to the game controller 710 through analog output 612.

With the Playstation 3 game console 700, the cradle 500 provides microphone input that originated at the headset 600 to the console 700 through the USB input. Sound from the console 700 is received from the analog input 512 and sent to the headset 600 through the wireless interfaces 530, 630.

Personal computers can use the USB port for both sound output and microphone input. In these environments, sound is received from the USB plug 510 and sent to the wireless headset 600 in digital form. Microphone input from the headset 600 is likewise transmitted to the cradle 500 and provided to the computer through USB plug 510.

As can be seen in the above examples, the cradle 500 receives sound input from either the USB plug 510 or the analog input 512. The choice of source for the wireless interface 530 can be made through a physical mode switch 560 on the cradle 500. The headset 630 can receive sound from either of these sources through its wireless interface 630, or from a local analog input 610. The microphone 620 on the headset 610 can output its signal either locally through the headset's analog output 612, or remotely through the USB port 510 or the analog output 514 of the docking cradle 500.

The digital sound received from the USB plug 510 can be switched between the wireless headset 600 and the local analog output 514 through the same techniques described above in connection with FIGS. 2-4. When the wireless interface 530 indicates that the wireless headset 600 is powered on and in communication with the cradle 500, the cradle 500 can be designed to provide sound only to the headset 600. If the headset 600 is not connected, the cradle 500 will provide sound output to the analog output port 514. As shown by connection 570, it would also be possible to submit the analog input 512 signal to chip 520 instead of connecting the analog input port 512 directly to the analog output 514. This would allow this source 512 to be switched between the headset 600 and the analog output 514 according to the connection status of the headset 600.

The many features and advantages of the invention are apparent from the above description. Numerous modifications and variations will readily occur to those skilled in the art. For instance, although the above examples show a USB port providing a digital interface between the dongle/charging stand/docking cradle and the computer or gaming console, it would be well within the scope of the present invention to use other digital connection techniques, both wired and wireless, in place of the USB connection. Since such modifications are possible, the invention is not to be limited to the exact construction and operation illustrated and described. Rather, the present invention should be limited only by the following claims.

What is claimed is:

1. A method of connecting to both a wireless sound output device and a wired sound output device without the need to change an audio configuration of a computing device, the method comprising:
a) connecting a transmitter device that is removable from the computing device to a sound output port of the computer device for the reception of a sound signal;
b) detecting whether the transmitter device is in wireless communication with the wireless sound output device;
c) if the transmitter device is in wireless communication with the wireless sound output device, sending the sound signal over an antenna on the transmitter device to the wireless sound output device; and
d) if the transmitter device is not in wireless communication with the wireless sound output device, sending the sound signal over a wired sound output port found on the transmitter device to the wired sound output device.

2. The method of claim 1, wherein the computing device is chosen from a personal computer and a gaming console, and further wherein the sound output port of the computer device is a USB connection.

3. A transmitter apparatus for a wireless audio output device comprising:
a) an audio input connection for receiving audio signals;
b) an antenna for sending the audio signals to the wireless audio output device;
c) a wired connection interface for sending the audio signals to a wired audio output device;
d) an audio signal director for directing the audio signal from the audio input connection to either the antenna or the wired connection interface, wherein the determination of how the audio signal is directed is based upon whether the wireless audio output device is powered on and in range of the transmitter apparatus.

4. The transmitter apparatus of claim 3, wherein the audio input connection is a digital connection.

5. The transmitter apparatus of claim 4, wherein the audio input connection is a USB connection.

6. The transmitter apparatus of claim 3, wherein the wired connection interface is chosen from among a set of interfaces consisting of a USB interface and an analog audio interface.

7. The transmitter apparatus of claim 3, further comprising a charging adapter that is adapted to provide charging power to the wireless audio output device.

8. A wireless sound system comprising:
a) a wireless sound output device having
i) at least one speaker for sound output, and
ii) a remote wireless interface.
b) a base having
i) a base sound input port,
ii) a base sound output port,
iii) a base wireless interface for wireless communication with the remote wireless interface thereby allowing sound signals received at the base to be transmitted to and played by and the wireless sound output device, the base wireless interface creating a connection status indicative of whether a connection has been made to the wireless sound output device,
iv) circuitry for directing the sound signals between the base sound output port and the wireless sound output device, wherein this choice of outputs is based upon the connection status.

9. The wireless sound system of claim 8, wherein the wireless sound output device has a rechargeable battery, and further the base has a charging circuit for recharging the chargeable battery when the wireless sound output device is connected to the base.

10. The wireless sound system of claim 8, wherein the base sound input port is a USB port, and the base sound output port is a USB port.

11. The wireless sound system of claim 8, wherein the base sound input port is a USB port, and the base sound output port is an analog port.

12. The wireless sound system of claim 8, wherein both the base sound input port and the base sound output port are digital connections.

13. The wireless sound system of claim 8, wherein the base sound input port is an analog port.

14. The wireless sound system of claim 8, wherein the base sound input port is a digital connection, and further wherein the base has an analog sound input port, wherein both input ports are switched by the circuitry for directing the sound signals between the wireless sound output device and the base sound output port.

15. The wireless sound system of claim 14, wherein the base further comprises a mode switch to select between the digital connection and the analog sound input port for the signal to be sent to the wireless sound output device.

16. The wireless sound system of claim 8, wherein the wireless sound output device further includes a microphone that receives microphone input, wherein the microphone input is sent via the remote wireless interface to the base.

17. The wireless sound system of claim 16, further comprising a digital output port on the base for sending out the microphone input received over the base wireless interface.

18. The wireless sound system of claim 17, wherein the wireless sound output device further includes a remote analog output port for outputting the microphone input.

19. The wireless sound system of claim 18, wherein the wireless sound output device further includes a remote analog input for receiving sound input for the at least one speaker.

20. The wireless sound system of claim 19, wherein the sound input from the remote analog input and sound received from the base over the remote wireless interface are simultaneously output over the at least one speaker.
